(19) United States
(12) Patent Application Publication
(10) Pub. No.: US 2026/0081631 A1
(43) Pub. Date: Mar. 19, 2026

(54) BI-DIRECTIONAL AMPLIFIER MODULE AND ADJUSTMENT METHOD

(71) Applicant: Alps Alpine Co., Ltd., Tokyo (JP)

(72) Inventors: Kazuhiro AOYAGI, Shanghai (CN); Tsutomu KUNISHIMA, Miyagi-ken (JP); Takeshi IISAKA, Miyagi-ken (JP)

(21) Appl. No.: 19/312,978

(22) Filed: Aug. 28, 2025

(30) Foreign Application Priority Data
Sep. 19, 2024 (JP) 2024-162118

(51) Int. Cl. H04B 1/04

(52) U.S. Cl. CPC H04B 1/0475; H04B 2001/0408

(57) ABSTRACT

A bi-directional amplifier module includes an antenna-side terminal, a body-side terminal, a signal amplification circuit disposed between the antenna-side terminal and the body-side terminal and configured to adjust a gain of a transmission RF signal, a state detection for detecting whether a transmission state or a reception state, an output level detection for detecting an RF output level of an antenna, and a controller configured to switch a transmission state and a reception state of the signal amplification circuit. The controller acquires the RF output level when the transmission state is detected, when the transmission state has changed to the reception state, after a predetermined waiting time has elapsed, confirms that the detection of the reception state has continued, and when the detection of the reception state has continued, adjusts the gain of the transmission RF signal based on the acquired RF output level.

### CLAIM OF PRIORITY

This application claims benefit of Japanese Patent Application No. 2024-162118 filed on Sep. 19, 2024, which is hereby incorporated by reference.

### BACKGROUND OF THE INVENTION

### 1. Field of the Invention

The present invention relates to a bi-directional amplifier module and an adjustment method.

### 2. Description of the Related Art

International Publication No. 2020-059172 discloses a technology for attenuating the signal level of a transmission signal to an appropriate predetermined level by using an attenuator connected in series to a power amplifier (PA) in an amplifier module disposed between an antenna and a main body.

In the technology in International Publication No. 2020-059172, however, it is not possible to control the attenuator, and when the signal level of a transmission signal fluctuates, the signal level of the transmission signal is not kept constant. In addition, in the technology in International Publication No. 2020-059172, if the attenuator is controlled while the transmission processing of the transmission signal is being performed, the transmission signal may be degraded.

### SUMMARY OF THE INVENTION

A bi-directional amplifier module according to an aspect includes an antenna-side terminal connected to an antenna, a body-side terminal connected to a main body, a signal amplification circuit disposed between the antenna-side terminal and the body-side terminal and configured to adjust a gain of a transmission RF signal, a state detection configured to detect whether a transmission state or a reception state, an output level detection configured to detect an RF output level of the antenna, and a controller configured to switch a transmission state and a reception state of the signal amplification circuit. The controller acquires the RF output level from the output level detection when the transmission state is detected by the state detection, when it is detected by the state detection that the transmission state has changed to the reception state, after a predetermined waiting time has elapsed, confirms that the detection of the reception state by the state detection has continued, and when it is confirmed that the detection of the reception state has continued, adjusts the gain of the transmission RF signal based on the acquired RF output level.

A bi-directional amplifier module according to an aspect adjusts an RF output level to a predetermined output level without degrading a transmission RF signal.

### BRIEF DESCRIPTION OF THE DRAWINGS

FIG. 1 is a diagram illustrating a configuration of a bi-directional amplifier module according to an embodiment;

FIG. 2 is a flowchart illustrating an example of a processing procedure to be performed by a controller in a bi-directional amplifier module according to an embodiment; and

FIG. 3 is a timing chart illustrating examples of timing for adjusting an attenuator in a bi-directional amplifier module according to an embodiment.

### DESCRIPTION OF THE PREFERRED EMBODIMENTS

Hereinafter, an embodiment will be described with reference to the attached drawings.

### Configuration of Bi-Directional Amplifier Module 100

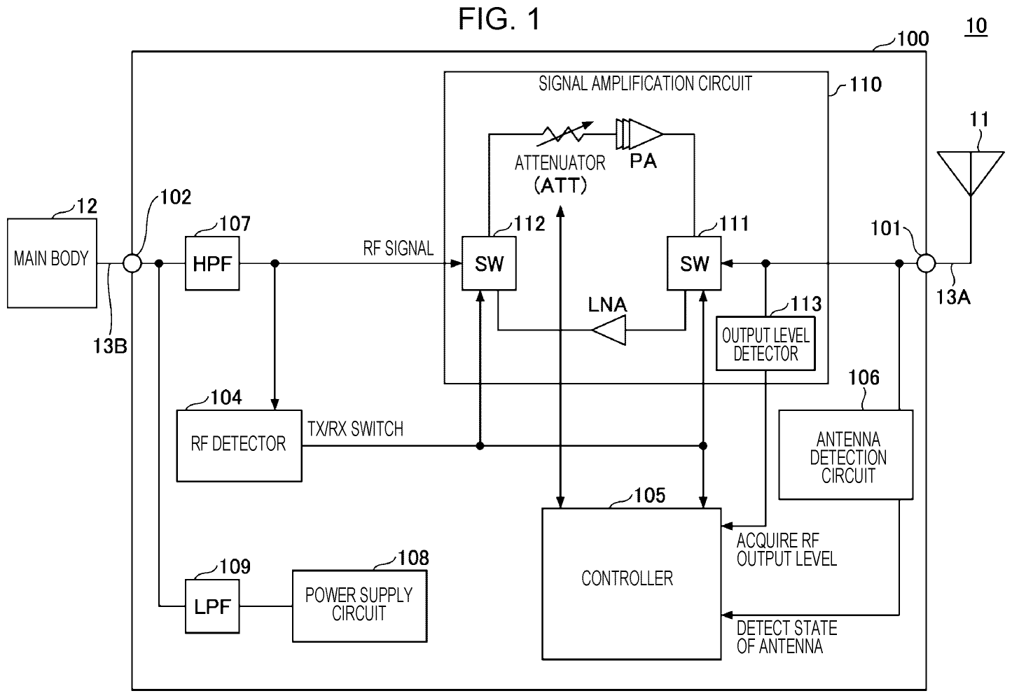

FIG. 1 is a diagram illustrating a configuration of a bi-directional amplifier module 100 according to an embodiment. A wireless communication system 10 illustrated in FIG. 1 is provided in vehicles such as automobiles to implement both Cellular V2X (C-V2X) communication and Dedicated Short Range Communication (DSRC). As illustrated in FIG. 1, the wireless communication system 10 includes an antenna 11, a main body 12, and the bi-directional amplifier module 100.

The bi-directional amplifier module 100 includes an antenna-side terminal 101, a body-side terminal 102, a signal amplification circuit 110, a radio frequency (RF) detector 104, a controller 105, an antenna detection circuit 106, a high pass filter (HPF) 107, a power supply circuit 108, and a low pass filter (LPF) 109.

The antenna-side terminal 101 is connected to the antenna 11 via a cable 13A and transmits and receives RF signals to and from the antenna 11. The body-side terminal 102 is connected to the main body via a cable 13B and transmits and receives RF signals to and from the main body 12.

The signal amplification circuit 110 is disposed between the antenna-side terminal 101 and the body-side terminal 102, and amplifies RF signals transmitted to and received from the antenna 11. The signal amplification circuit 110 includes a switch 111 that is disposed on the antenna-side terminal 101 side, a switch 112 that is disposed on the body-side terminal 102 side, a transmission amplifier PA and a reception amplifier LNA that are disposed in parallel between the switch 111 and the switch 112, an attenuator ATT, and an output level detector 113. The transmission amplifier PA amplifies transmission RF signals. The reception amplifier LNA amplifies reception RF signals. The attenuator ATT is connected in series to the transmission amplifier PA and adjusts the gain of transmission RF signals for the transmission amplifier PA. The output level detector 113 is an example of “output level detection”, and detects an RF output level of the antenna 11.

The RF detector 104 is an example of a “state detection”, and detects transmission and reception states of RF signals. More specifically, the RF detector 104 detects whether a state is a state in which a transmission RF signal is transmitted to the antenna 11 (hereinafter, referred to as a “transmission state”) or a state in which a reception RF signal is received from the antenna 11 (hereinafter, referred to as a “reception state”).

The controller 105 switches a transmission state and a reception state of the signal amplification circuit 110.

For example, when a transmission state is detected by the RF detector 104, the controller 105 switches the switch 111 and the switch 112 to the transmission amplifier PA side to switch the signal amplification circuit 110 to be in a state in which the transmission RF signal is amplified by the transmission amplifier PA.

When a reception state is detected by the RF detector 104, the controller 105 switches the switch 111 and the switch 112 to the reception amplifier LNA side to switch the signal amplification circuit 110 to be in a state in which the reception RF signal is amplified by the reception amplifier LNA.

The controller 105 controls the attenuator ATT in the signal amplification circuit 110 to adjust the gain of transmission RF signals for the transmission amplifier PA.

More specifically, the controller 105 adjusts the attenuator ATT based on the RF output level of the antenna 11 detected by the output level detector 113 to adjust the gain of transmission RF signals, and thereby adjusts the RF output level of the antenna 11 to a predetermined output level (e.g., +23 dBm).

The controller 105 is a device such as a microcomputer provided with, for example, a processor, memory, and other elements, and executes a program stored in the memory using the processor to implement each function of the controller 105.

The antenna detection circuit 106 detects a state of the antenna 11.

The HPF 107 is disposed between the body-side terminal 102 and the signal amplification circuit 110. The HPF 107 prevents direct current power that is input via the body-side terminal 102 from passing through, thereby preventing the direct current power from being supplied to the signal amplification circuit 110.

The power supply circuit 108 supplies direct current power to each element in the bi-directional amplifier module 100 via a power supply line (not illustrated) using direct current power input via the body-side terminal 102.

The LPF 109 is disposed between the body-side terminal 102 and the power supply circuit 108. The LPF 109 prevents RF signals that are input via the body-side terminal 102 from passing through, thereby preventing the RF signals from being supplied to the power supply circuit 108.

### Example of Processing Procedure Performed by Controller 105

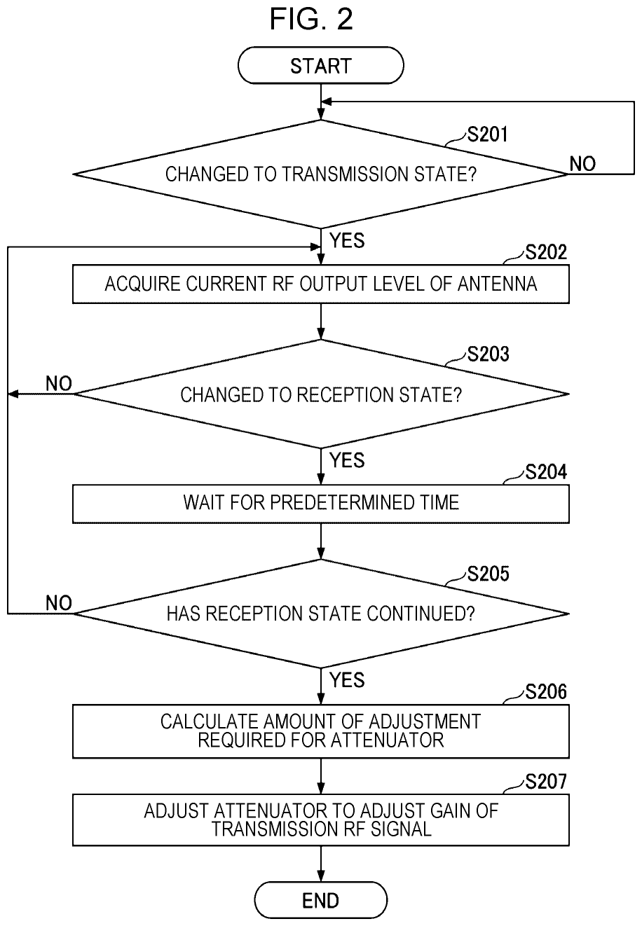

FIG. 2 is a flowchart illustrating an example of a processing procedure to be performed by the controller 105 in the bi-directional amplifier module 100 according to an embodiment.

First, the controller 105 determines whether a transmission/reception state of an RF signal detected by the RF detector 104 has changed from a reception state to a transmission state (step S201).

In step S201, when it is determined that the state has not changed from the reception state to the transmission state (step S201: NO), the controller 105 executes step S201 again.

In step S201, when it is determined that the state has changed from the reception state to the transmission state (step S201: YES), the controller 105 acquires the current RF output level of the antenna 11 from the output level detector 113 (step S202: RF output level acquisition step).

Next, the controller 105 determines whether the transmission/reception state of the RF signal detected by the RF detector 104 has changed from the transmission state to the reception state (step S203).

In step S203, when it is determined that the state has not changed from the transmission state to the reception state (step S203: NO), the controller 105 returns the processing to S202.

In step S203, when it is determined that the state has changed from the transmission state to the reception state (step S203: YES), the controller 105 waits for a predetermined waiting time (for example, 100 μs) (step S204), and then determines whether the transmission/reception state of the RF signal detected by the RF detector 104 continues to be the reception state (step S205: confirmation step).

In step S205, when it is determined that the reception state has not continued (step S205: NO), the controller 105 returns the processing to S202.

In step S205, when it is determined that the reception state has continued (step S205: YES), the controller 105 calculates an amount of adjustment required for the attenuator ATT to adjust the RF output level of the antenna 11 to a predetermined output level (e.g., +23 dBm) based on the RF output level acquired in step S202 (step S206: adjustment step).

Then, the controller 105 adjusts the attenuator ATT by the adjustment amount calculated in step S206 (step S207). As a result, the controller 105 can adjust the RF output level of the antenna 11 to a predetermined level (e.g., +23 dBm).

The controller 105 then ends the sequence of processing in FIG. 2. Even when the RF output level of the antenna 11 fluctuates, the controller 105 can maintain the RF output level of the antenna 11 to a predetermined level (e.g., +23 dBm) by repeatedly performing the sequence of processing in FIG. 2.

It is preferable that the predetermined waiting time be longer than a minimum data transmission interval of the transmission RF signal. For example, when the minimum data transmission interval is 80 μs, it is preferable that the above-described waiting time be longer than 80 μs (e.g., 100 μs). This enables the controller 105 to adjust the attenuator ATT when the transmission of the next transmission RF signal has not started after the minimum data transmission interval has elapsed, and not to adjust the attenuator ATT when the transmission of the next transmission RF signal has started after the minimum data transmission interval has elapsed.

### Example of Timing for Adjusting Attenuator ATT

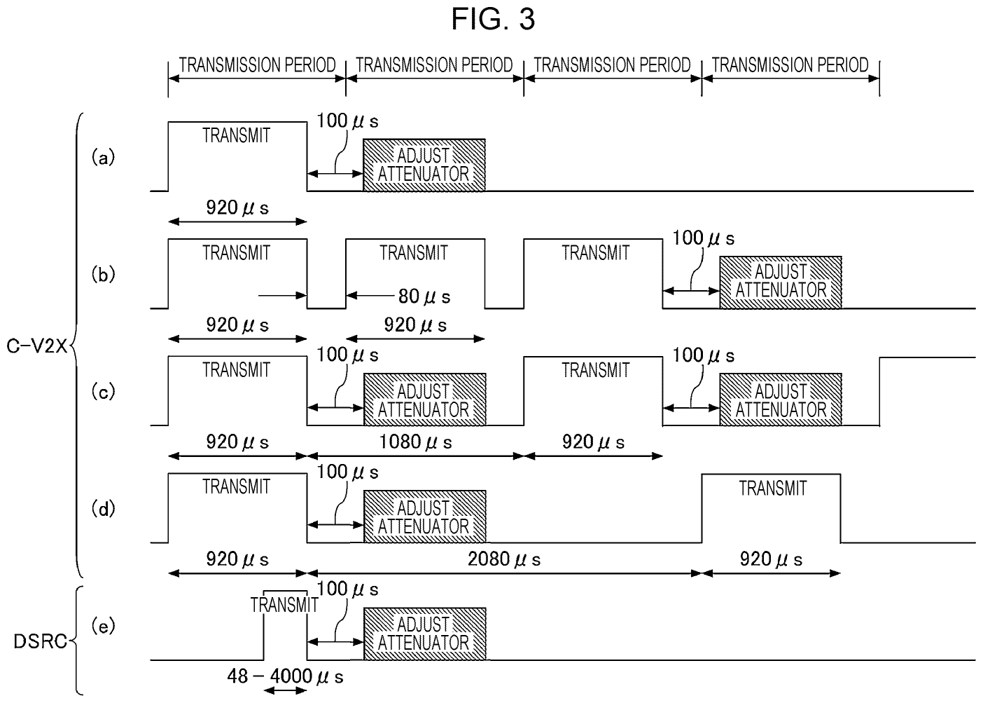

FIG. 3 is a timing chart illustrating examples of timing for adjusting the attenuator ATT in the bi-directional amplifier module 100 according to an embodiment. Example (a) shows the timing for adjusting the attenuator ATT by using the controller 105 when a C-V2X-format transmission RF signal is transmitted in the first transmission period. Example (b) shows the timing for adjusting the attenuator ATT by using the controller 105 when a C-V2X-format transmission RF signal is transmitted in the first, second, and third transmission periods.

Example (c) shows the timing for adjusting the attenuator ATT by using the controller 105 when a C-V2X-format transmission RF signal is transmitted in the first and third transmission periods. Example (d) shows the timing for adjusting the attenuator ATT by using the controller 105 when a C-V2X-format transmission RF signal is transmitted in the first and fourth transmission periods.

As illustrated in Examples (a) through (d) in FIG. 3, after the transmission of the transmission RF signal is completed (i.e., after the “transmission state” is switched to the “reception state”), when a predetermined waiting time has elapsed and the “reception state” still continues (i.e., when the transmission of the next transmission RF signal has not started), the controller 105 starts the adjustment of the attenuator ATT.

More specifically, in the examples shown in Examples (a) through (d) in FIG. 3, the minimum data transmission interval of the C-V2X-format transmission RF signal is 80 μs, and the controller 105 sets the predetermined waiting time to 100 μs, which is longer than 80 μs.

This enables the controller 105 to adjust the attenuator ATT only when the transmission of the transmission RF signal is completed in a transmission period and the transmission RF signal is not transmitted in the next transmission period. In other words, the controller 105 can avoid simultaneous transmission of the transmission RF signal and adjustment of the attenuator ATT, thereby suppressing degradation of the transmission RF signal.

For example, in the example shown in Example (a), the controller 105 does not adjust the attenuator ATT in the first transmission period in which the transmission RF signal is transmitted, and can adjust the attenuator ATT in the second transmission period in which the transmission RF signal is not transmitted.

For example, in the example shown in Example (b), the controller 105 does not adjust the attenuator ATT in the first, second, and third transmission periods in which the transmission RF signal is transmitted, and can adjust the attenuator ATT in the fourth transmission period in which the transmission RF signal is not transmitted.

For example, in the example shown in Example (c), the controller 105 does not adjust the attenuator ATT in the first and third transmission periods in which the transmission RF signal is transmitted, and can adjust the attenuator ATT in the second and fourth transmission periods in which the transmission RF signal is not transmitted.

For example, in the example shown in Example (d), the controller 105 does not adjust the attenuator ATT in the first and fourth transmission periods in which the transmission RF signal is transmitted, and can adjust the attenuator ATT in the second transmission period in which the transmission RF signal is not transmitted.

As shown in Exampled (a) through (d) in FIG. 3, the controller 105 starts the adjustment of the attenuator ATT in a transmission period of the transmission RF signal, and completes the adjustment of the attenuator ATT before the start of the next transmission period of the transmitting RF signal. Accordingly, the controller 105 can avoid simultaneous transmission of the transmission RF signal and adjustment of the attenuator ATT, thereby suppressing degradation of the transmission RF signal.

It should be noted that Example (e) in FIG. 3 shows the timing for adjusting the attenuator ATT by using the controller 105 when a DSRC-format transmission RF signal is transmitted in the first transmission period. In this case, after the transmission of the DSRC-format transmission RF signal is completed (i.e., after the “transmission state” is switched to the “reception state”), when a predetermined waiting time has elapsed and the “reception state” still continues (i.e., when the transmission of the next DSRC-format transmission RF signal has not started), the controller 105 starts the adjustment of the attenuator ATT.

This enables the controller 105 to adjust the attenuator ATT only when the transmission of the DSRC-format transmission RF signal is completed and the next DSRC-format transmission RF signal is not transmitted.

That is, the bi-directional amplifier module 100 according to one embodiment is capable of transmitting and receiving not only C-V2X-format RF signals but also DSRC-format RF signals.

In addition, the controller 105 can avoid simultaneous transmission of a DSRC-format transmission RF signal and adjustment of the attenuator ATT, thereby suppressing degradation of the DSRC-format transmission RF signal.

It should be noted that, in the example shown in Example (e) in FIG. 3, the minimum data transmission interval of the DSRC-format transmission RF signal is 80 μs, and the controller 105 sets the predetermined waiting time to 100 μs, which is longer than 80 μs.

While the embodiments of the present invention have been described in detail, it is to be understood that the invention is not limited to these embodiments, various modifications or changes may be made within the scope of the invention.

What is claimed is:

1. A bi-directional amplifier module comprising:
an antenna-side terminal connected to an antenna;
a body-side terminal connected to a main body;
a signal amplification circuit disposed between the antenna-side terminal and the body-side terminal and configured to adjust a gain of a transmission RF signal;
a state detection configured to detect whether a transmission state or a reception state;
an output level detection configured to detect an RF output level of the antenna; and
a controller configured to switch a transmission state and a reception state of the signal amplification circuit, wherein
the controller
acquires the RF output level from the output level detection when the transmission state is detected by the state detection,
when it is detected by the state detection that the transmission state has changed to the reception state, after a predetermined waiting time has elapsed, confirms that the detection of the reception state by the state detection has continued, and
when it is confirmed that the detection of the reception state has continued, adjusts the gain of the transmission RF signal based on the acquired RF output level.

2. The bi-directional amplifier module according to claim 1, wherein the predetermined waiting time is longer than a minimum data transmission interval of the transmission RF signal.

3. The bi-directional amplifier module according to claim 2, wherein the predetermined waiting time is longer than the minimum data transmission interval of the transmission RF signal of the Cellular V2X (C-V2X) format.

4. The bi-directional amplifier module according to claim 3, wherein
the controller
after the controller starts the adjustment of the gain of the C-V2X-format transmission RF signal, and before the next transmission period of the C-V2X-format transmission RF signal starts, completes the adjustment of the gain of the C-V2X-format transmission RF signal.

5. The bi-directional amplifier module according to claim 1, wherein
the signal amplification circuit includes
a transmission amplifier configured to amplify the transmission RF signal;
a reception amplifier configured to amplify a reception RF signal; and
an attenuator configured to adjust a gain of the transmission RF signal, and the controller
adjusts the attenuator to adjust a gain of the transmission RF signal.

6. A method of adjusting a gain of a transmission RF signal by using a bi-directional amplifier module disposed between a main body and an antenna and configured to switch a transmission state and a reception state, the method comprising:
an RF output level acquisition step of acquiring an RF output level of the antenna in the transmission state;
a confirmation step of, when the transmission state has changed to the reception state, after a predetermined waiting time has elapsed, confirming whether the reception state has continued; and
an adjustment step of, when it is confirmed in the confirmation step that the reception state has continued, adjusting the gain of the transmission RF signal based on the acquired RF output level.
